(19) United States
(12) Patent Application Publication
(10) Pub. No.: US 2010/0225110 A1
(43) Pub. Date: Sep. 9, 2010

(54) SEALING WASHER WITH MULTIPLE SEALING RINGS

(76) Inventors: Dean Christie, Royal Oak, MI (US); Chhotu Patel, Phoenix, AZ (US)

Correspondence Address: BUTZEL LONG;IP DOCKETING DEPT, 350 SOUTH MAIN STREET, SUITE 300, ANN ARBOR, MI, 48104, US

(21) Appl. No.: 12/399,427

(22) Filed: Mar. 6, 2009

(51) Int. Cl. F16L 21/02; F16J 15/02

(52) U.S. Cl. 285/351; 277/637

(57) ABSTRACT

A sealing washer, comprising a rigid body having opposite, disc-shaped surfaces defining parallel planes, and a central opening defined through the rigid body along a central axis thereof; and multiple, concentric, polymeric sealing rings projecting away from the plane defined by each of the disc-shaped surfaces of the rigid body, the sealing rings being generally coaxial with the central axis, and each sealing ring being deformable in response to compression forces applied to the plane defined by each disc-shaped surface.

### FIELD OF THE INVENTION

The present invention generally relates to sealing washers, such as for use, for example, in block connectors found in vehicle air-conditioning systems and the like, and more particularly to such sealing washers characterized by multiple, concentric sealing rings.

### BACKGROUND

Block connectors are commonly employed in vehicle air-conditioning and other fluid-transfer systems where they serve to connect discrete sections of a common fluid line. As exemplified in FIG. 1, such block connectors are generally characterized by mateable male 10 and female 20 connectors that capture therebetween one end of a fluid line in sealed relation with an adjoining section of the fluid line. More particularly, the male connector 10 includes a conduit passage 11 dimensioned to receive the end of a conduit 30 therethrough, and a fastener passage 12 laterally offset from the conduit passage 11. Conduit passage 11 includes a counter-bored opening 13 of larger diameter which is dimensioned to receive therein the larger-diameter circumferential flange 31 defined on the conduit 30. The female connector 20 includes a conduit port 21 dimensioned to receive a terminal, pilot portion of the conduit 30 therein, and a fastener stud 40, such as the threaded bolt shaft or stud depicted, mounted in laterally offset relation to the conduit port 21. Conduit port 21 will typically have secured thereto, and in fluid communication therewith, a section of fluid line (not shown) which extends from the female connector 20 to another location along the fluid line.

In use, conduit 30 is inserted into the conduit passage 11 of male connector 10 so that flange 31 is received in opening 13, whereupon the pilot end of the conduit 30 is inserted into conduit port 21 while, simultaneously, the male connector is positioned so that the fastener stud 40 is received through fastener passage 12. A fastener 41, such as the illustrated nut, is thereafter tightened on the fastener stud 40 to fix the male 10 and female 20 connectors together so that the conduit 30 is trapped between them in secure interconnection with the conduit port 21.

Sealing the interconnection between conduit 20 and conduit port 12 in the thus-assembled block connector is conventionally accomplished by any of a variety of means, including the employment of one or more O-rings 45 positioned about the circumference of the conduit pilot-end so as to be compressed upon insertion of the pilot end into the conduit port 12.

Still another conventionally employed sealing means has been sealing washers, such as shown in FIGS. 2A through 2C. As shown, such sealing washers generally comprise a metal body 50 with opposite, disc-shaped surfaces 51, 52 defining parallel planes, and a central opening 53 defined through the body along a central axis. A single polymeric sealing ring 60a or 60b projects away from each of the disc-shaped surfaces 51, 52. Furthermore, an annular polymeric lip 61 extends from the washer body 50 into the central opening 53, the lip 61 constituting an extension of, and formed integrally with, the sealing rings 60a, 60b, as best shown in FIG. 2C. With reference being had to the exemplary block connector of FIG. 1, in use, the pilot end of the conduit 30 is inserted through the central opening 53 so that the washer, substituted for the O-ring of FIG. 1, is compressed between the conduit flange 31 and the mating surface of the female connector block 20 in the assembled connector block. Under such axial compression, the sealing rings 60a, 60b are compressed against the opposed surfaces of the conduit flange 31 and the mating surface of the female connector block 20 to form a fluid seal. Further, such compression urges the lip 61 into sealing contact with the exterior surface of the fluid conduit 30.

Irrespective of whether O-rings or sealing washers are employed as the sealing means, it remains the case that connector blocks, while advantageous for their facile employment and robust construction, continue to be plagued by the eventual intrusion of foreign material between the male and female connectors and, ultimately, into the area occupied by the sealing means. Relative to the sealing means, the intrusion of such foreign materials can compromise the seal or even break down the material of the sealing means leading, in either case, to leaks.

In light of the foregoing, there exists a need for some means for precluding, or at least substantially reducing, the intrusion of foreign materials into the area of block-style connectors occupied by the sealing means.

### SUMMARY OF THE INVENTION

According to the present invention, there is provided a sealing washer comprising a rigid body having opposite, disc-shaped surfaces defining parallel planes, and a central opening defined through the rigid body along a central axis thereof; and multiple, concentric, polymeric sealing rings projecting away from the plane defined by each of the disc-shaped surfaces of the rigid body, the sealing rings being generally coaxial with the central axis, and each sealing ring being deformable in response to compression forces applied to the plane defined by each disc-shaped surface.

Per one feature of the invention, the multiple polymeric sealing rings projecting away from the plane defined by each of the disc-shaped surfaces of the rigid body each project to the same height as measured from the apex of each such sealing ring to the plane defined by the disc-shaped surface from which they project. In another embodiment, one or more of the multiple polymeric sealing rings projecting away from the plane defined by each of the disc-shaped surfaces of the rigid body may project to a different height than the other polymeric sealing rings. For instance, each of the multiple, concentric polymeric sealing rings projecting away from the plane defined by each of the disc-shaped surfaces of the rigid body may project to a different height, with the height of each successive concentric sealing ring increasing as measured in the direction from the central opening moving radially outwardly. Alternatively, where at least three such concentric polymeric sealing rings project away from the plane defined by each of the disc-shaped surfaces of the rigid body, the two innermost of the at least three concentric polymeric sealing rings may project to the same height, while the height of each successive concentric sealing ring, as measured in the direction from the central opening moving radially outwardly, projects to a greater height than the two innermost sealing rings.

According to one feature hereof, the rigid body may be made of metal, including by way of non-limiting example, aluminum, steel, etc.

Per one embodiment of the invention, two polymeric sealing rings project away from the plane defined by each of the disc-shaped surfaces of the rigid body. In another embodiment, three or even more such polymeric sealing rings are provided on each of the disc-shaped surfaces of the rigid body.

According to another feature of the invention, the rigid body is at least partially covered with a polymeric coating. Further to this feature, the sealing rings are formed integrally with the polymeric coating. The rigid body may, alternatively, be completely covered with the polymeric coating.

Per still another feature, the sealing washer further comprises an annular polymeric lip comprising extending from the rigid body into the central opening. Where the rigid body is at least partially covered with a polymeric coating, both the sealing rings and the annular polymeric lip are all integrally formed with the polymeric coating.

While not limited to such application, the inventive sealing washer may be employed in connection with block connectors of the type comprising a male connector having a conduit passage and at least one fastener passage laterally offset from the conduit passage, a female connector having a conduit port and at least one fastener stud laterally offset from the conduit port and receivable within the at least one fastener passage, a conduit disposed in the conduit passage and receivable within the conduit port. According to such application, the sealing washer is disposed about an exterior surface of the conduit and compressed between the male and female connectors to form a fluid-tight seal.

### BRIEF DESCRIPTION OF THE DRAWINGS

For a better understanding of the present invention and to show more clearly how it may be carried into effect, reference will now be made, by way of example, to the accompanying drawings, which show an exemplary embodiment of the present invention, and in which:

FIG. 1 is a partial cross section of a connector block according to the prior art;

FIG. 2A is a top-down view of a sealing washer according to the prior art;

FIG. 2B is a lateral cross-sectional view of the sealing washer of FIG. 2A;

FIG. 2C is a detailed section of FIG. 2B;

FIG. 3A is a top-down view of a sealing washer according to the present invention;

FIG. 3B is a lateral cross-sectional view of the sealing washer of FIG. 3A;

FIG. 3C is a detailed section of FIG. 3B;

FIG. 4 is a detailed lateral cross-sectional view of a sealing washer according to an alternative embodiment of the present invention;

FIG. 5A is a top-down view of a sealing washer according to another alternative embodiment of the present invention;

FIG. 5B is a detailed lateral cross-sectional view of a sealing washer according to the embodiment of FIG. 5A;

FIG. 6 is a detailed lateral cross-sectional view of a sealing washer according to a still further alternative embodiment of the present invention;

FIGS. 7 and 8 are exploded, quartering perspectives of a block connector in which the sealing washer of the present invention may be incorporated; and

FIG. 9 is detailed, lateral cross-sectional view of a portion of the block connector of FIGS. 7 and 8.

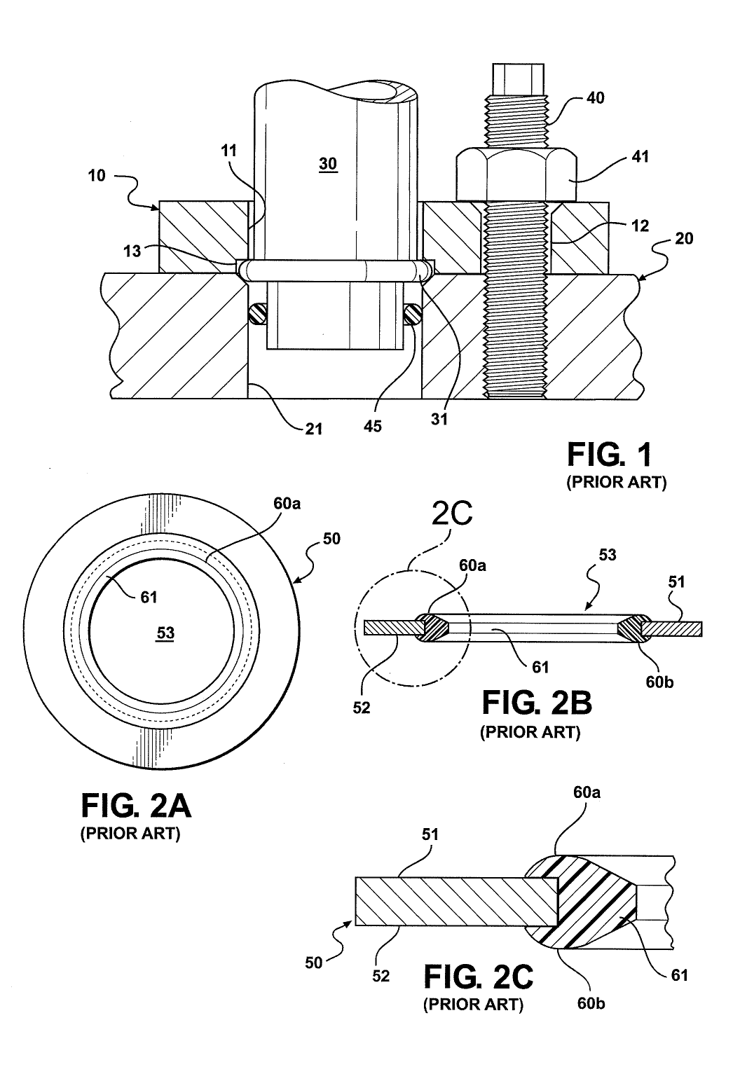

### WRITTEN DESCRIPTION

As required, detailed embodiments of the present invention are disclosed herein. However, it is to be understood that the disclosed embodiments are merely exemplary of the invention that may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

Referring now to the drawings, wherein like numerals refer to like or corresponding parts throughput the several views, the present invention is generally characterized as a sealing washer, such as for use, for example, in block connectors found in vehicle air-conditioning systems and the like. However, it will be appreciated from the following disclosure that the invention is suitable for employment in other operational environments where a fluid seal is required and it is desirable to avoid compromise of the seal by the intrusion of foreign materials into the space occupied thereby.

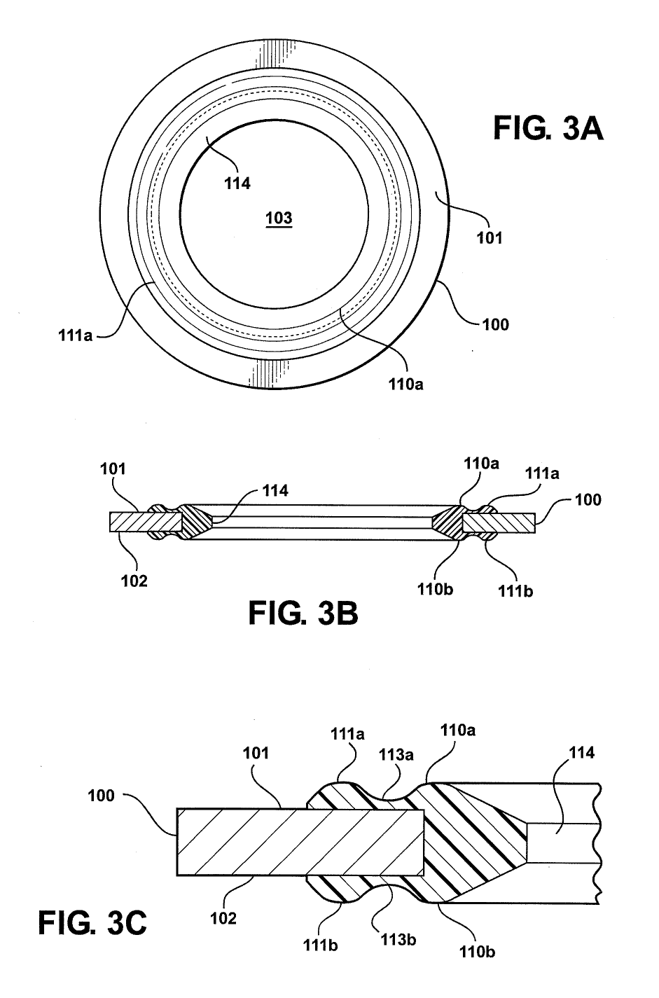

Referring now in detail to the drawings, and particularly to FIGS. 3A through 3C, the sealing washer of the present invention will be seen to most generally comprise a rigid body 100 having opposite, disc-shaped surfaces 101, 102 defining parallel planes, and a central opening 103 defined through the rigid body 100 along a central axis 104 thereof; and multiple, concentric, polymeric sealing rings 110a, 111a, 110b, 111b projecting away from the planes defined by the disc-shaped surfaces 101, 102 of the rigid body 100. Sealing rings 110a, 111a, 110b, 111b are, as depicted, generally coaxial with the central axis 104. Furthermore, it may be seen that, according to the illustrated embodiment, the sealing rings 110a, 111a projecting from the surface 101 are axially aligned with the sealing rings 110b, 111b projecting from the surface 102. It is contemplated, however, that these sealing rings 110a, 111a, 110b, 111b may be axially misaligned.

Each sealing ring 110a, 111a, 110b, 111b is preferably deformable in response to compression forces applied to the plane defined by each disc-shaped surface 101, 102, so as to increase the area of surface contact with the immediately adjacent surfaces with which they are in contact, all as described below in respect of an exemplary operational environment of the invention. But while it is important for sealing rings 110a, 110b to provide a fluid-tight seal, sealing rings 111a, 111b and, as provided, any additional, concentric sealing rings need not necessarily form a fluid-tight seal so long as the sealing rings 111a, 111b and any additional sealing rings act to seal against the intrusion of foreign materials which can compromise the fluid-tight seal formed by at least the sealing rings 110a, 110b. Of course, it is contemplated that one or more of the sealing rings (e.g., 111a, 111b, etc.) provided in addition to the sealing rings 110a, 110b may be dimensioned to form a fluid-tight seal as well.

Washer body 100 is, in the illustrated embodiment, characterized by a thickness (measured as the distance between the opposite surfaces 101, 102) of approximately 0.90 mm, an outside diameter of approximately 20.75 mm, and a diameter of approximately 14.00 mm for the central opening 103. These dimensions are selected for their suitability in a particular, and exemplary, block connector environment for an automotive fluid transfer system. They are not intended to be limiting of the invention and, accordingly, other dimensions may be selected according to the particular environment in which the sealing washer is to be employed.

According to the illustrated embodiment, the washer body 100 is fabricated from metal, and more particularly from an aluminum alloy such as, by way of example only, 6082-T6 or 5252-H22. Of course, other materials known in the art to be suited to employment in sealing washers and/or which are acceptable substitutes for the above-specified materials, may be selected in the alternative.

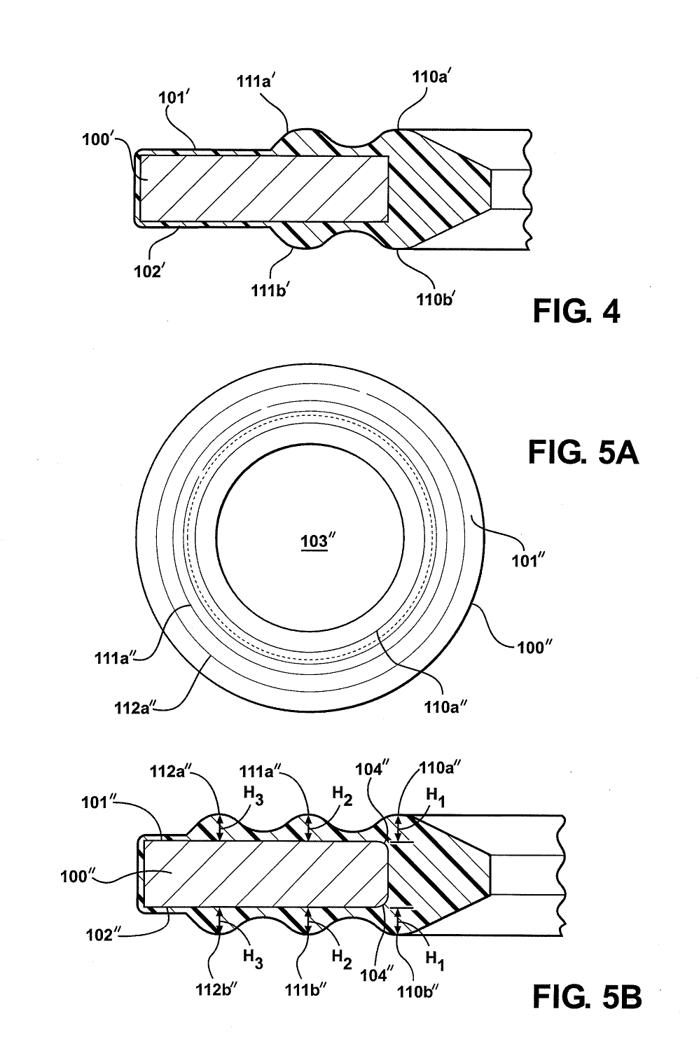

As best shown in FIGS. 3B and 3C, sealing rings 110a, 111a, 110b, 111b are, in the illustrated embodiment, formed integrally with a polymeric coating formed over at least a portion of the washer body 100. The formation of this coating, and the associated formation of the sealing rings 110a, 111a, 110b, 111b in connection therewith, may be accomplished according to conventional techniques. Optionally, the body 100′ may be completely covered with the polymeric coating, as shown in FIG. 4.

With continuing reference to FIGS. 3B and 3C, sealing rings 110a, 110b are each radiused in cross-section at the apex and, moving radially outwardly from the central opening 103, each slopes downwardly from its apex into a trough or annular groove 113a, 113b. Further defining the annular groove oppositely of the sealing rings 110a, 110b are the sealing rings 111a, 111b. In the illustrated embodiment, sealing rings 111a, 111b are characterized as annular projections of similar cross-sectional dimensions to sealing rings 110a, 110b. As noted, however, this correspondence is not absolutely necessary.

In the exemplary form of the sealing washer depicted, each of the pairs of sealing rings 110a, 111a and 110b, 111b are, between their respective apexes, spaced apart by a distance of approximately 3.4 mm. As with other dimensions indicated herein, the foregoing dimensions are selected for their suitability in a particular, and exemplary block connector environment for an automotive fluid transfer system. They are not intended to be limiting of the invention and, accordingly, other dimensions may be selected according to the particular environment in which the sealing washer is to be employed.

Continuing radially outwardly from the apex of sealing rings 111a, 111b, the polymeric coating terminates approximately where the slope of sealing rings 111a, 111b intersect a surface 101 or 102, respectively, of the washer body 100. As noted above, it is contemplated that the polymer coating may continue further toward the outer diameter of the washer body 100, and may even be continuous over the entire surface thereof, such as shown in the alternative embodiment of FIG. 4.

According to the illustrated embodiments, the polymer coating is rubber, and more particularly hydrogenated nitrile butadiene rubber (“HNBR”). HNBR is known to those skilled in the art to be well-suited to sealing applications. However, other materials, also known to those skilled in the art, may be substituted for HNBR.

Per convention, the sealing washer of the illustrated embodiment may further be provided with an annular polymeric lip 114 extending from body 100 and partially into the central opening 103. As shown, lip 114 is formed integrally with the polymer coating and is, more particularly, defined as a continuation of the sealing rings 110a, 110b. Still more particularly, it may be seen in FIG. 3C that the sealing rings 110a, 110b taper in cross-section gradually from their respective apexes on either of the surfaces 101, 102 of the body 100 into the central opening 103 to define the lip 114. This lip 114 in the illustrated embodiment extends approximately 1.35 mm into the opening 103, while the apex of each of the sealing rings 110a, 111a, 110b, 111b, 111b is defined approximately 0.35 mm above the respective surface 101, 102 from which the sealing ring projects. As with other dimensions indicated herein, the foregoing dimensions are selected for their suitability in a particular and exemplary block connector environment for an automotive fluid transfer system, and so are not intended to be limiting of the invention; other dimensions may be selected according to the particular environment in which the sealing washer is to be employed.

Referring next to FIGS. 5A and 5B, there is shown an alternative embodiment of the invention which is like the embodiment of FIGS. 3A through 3C in all respects except as noted. More particularly, the embodiment of FIGS. 5A and 5B is distinguished in that the body 100″ has a continuous polymeric coating such as shown in the embodiment of FIG. 4 (although this is optional) and there are provided three concentric, polymeric sealing rings 110a″, 111a″, 112a″ and 110b″, 111b″, 112b″ projecting from, respectively, each of the surfaces 101″ and 102″ of the body 100″. Further according to this embodiment, it will be seen that the spaced-apart edges 104″ of the body 100″ proximate the central opening 103″ are radiused to eliminate the sharp corners shown in the embodiments of FIGS. 3A through 3C and 4. As with the embodiments described hereinabove, the height H₁, H₂ and H₃ of sealing rings 110a″, 111a″, 112a″ and 110b″, 111b″, 112b″, as measured from the apexes of each to the respective surfaces 101″ and 102″ from which they project, is the same. Moreover, according to the illustrated embodiment, these heights H₁, H₂ and H₃ for each of the sealing rings 110a″, 111a″, 112a″ projecting from the surface 101″ are the same as the heights H₁, H₂ and H₃ for the corresponding sealing rings 110b′, 111b′, 112b″ projecting from the surface 102″. However, this does not necessarily have to be the case.

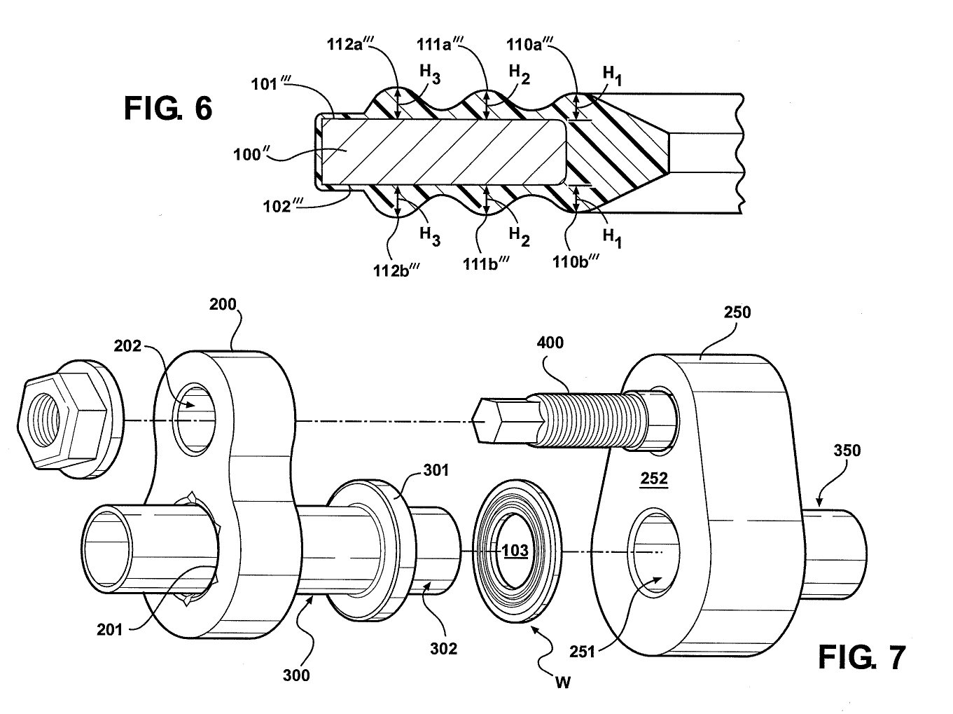

Turning then to FIG. 6, there is shown a still further embodiment of the invention which in all material respects is like the sealing washer of FIGS. 5A and 5B except in that the height H₁, H₂ and H₃ of each sealing ring 110a′″, 111a′″, 112a′″ and 110b′″, 111b′″, 112b′″, measured from the apexes of each to the respective surfaces 101′″ and 102′″ from which they project, is, beginning with the innermost sealing rings (110a′″, 110b′″) and moving outwardly from the central opening 103′″, successively higher; thus, height H₁of each sealing ring 110a′″, 110b′″ is less than height H₂ of each of sealing rings 111a′″, 111b′″, while height H₂ of each of sealing rings 111a′″, 111b′″ is less than height H₃ of each of sealing rings 112a′″, 112b′″. By this configuration, noise vibration and harshness may be further reduced, while balance may be improved. It is further contemplated that the sealing washer of the foregoing embodiment may be configured so that the heights H₁ and H₂ of each sealing ring 110a′″, 111a′″ and 110b′″, 111b′″ are the same, while the height H₃ for each of sealing rings 112a′″, 112b′″ (as well as any successive concentric sealing rings Hₙ, Hₙ₊₁, etc.) is higher; thus, height H₁ of each sealing ring 110a′″, 110b′″ is the same as height H₂ of each of sealing rings 111a′″, 111b′″, while height H₃ for each of sealing rings 112a′″, 112b′″ is greater than the heights H₁, H₂ of sealing rings 110a′″, 110b′″, 111a′″, 111b′″ (and, where further sealing rings are provided, their respective heights Hₙ, Hₙ₊₁, etc. are successively higher). According to the foregoing embodiment, and as with the previously described embodiments, the various heights H₁, H₂ and H₃ (and, where further sealing rings are provided, heights Hₙ, Hₙ₊₁) for corresponding pairs of the sealing rings 110a′″ and 110b′″, 111a′″ and 111b′″, 112a′″ and 112b′″ (etc.) projecting from opposite surfaces 101′″ and 102′″ are the same, although this does not necessarily have to be the case.

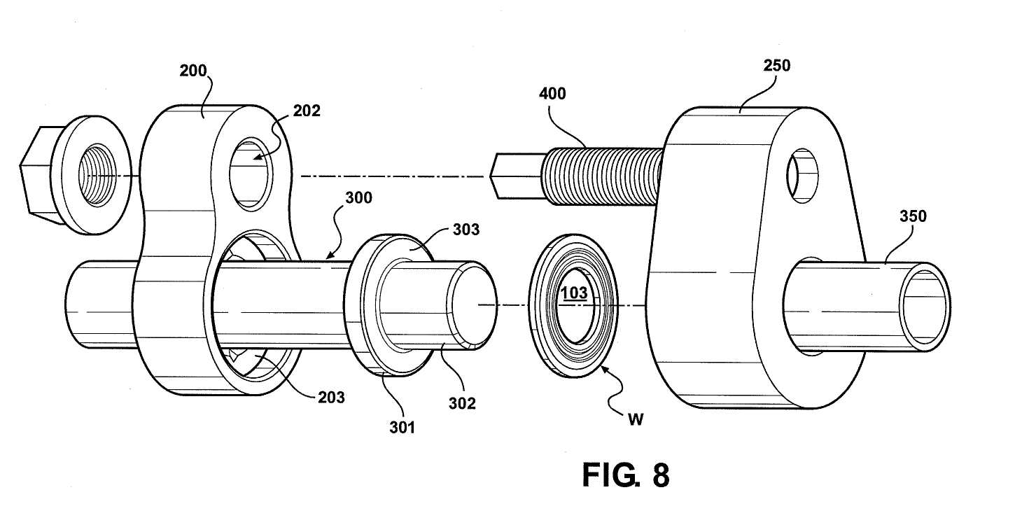

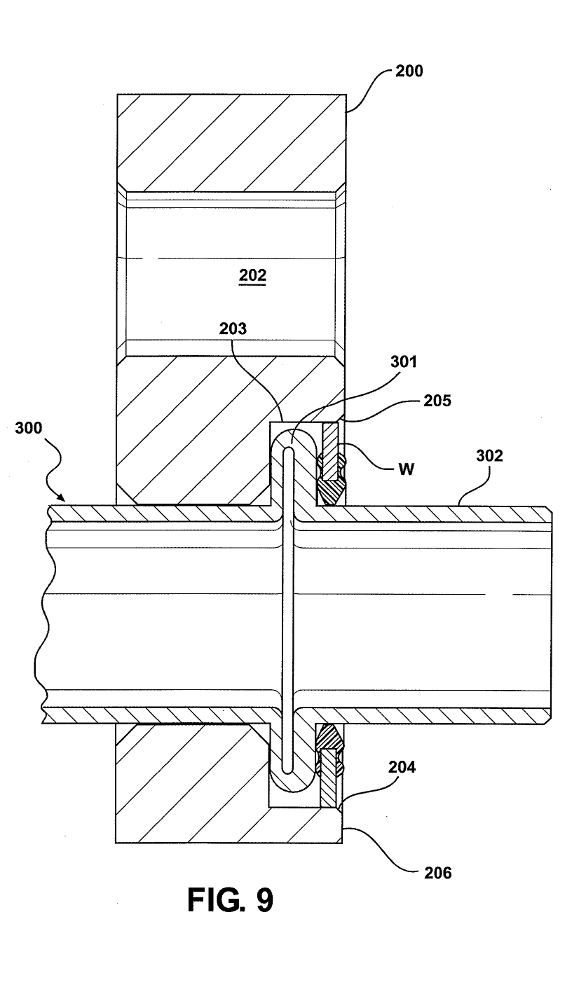

Turning now to FIGS. 7 through 9, there is shown an exemplary block connector incorporating the sealing washer of the present invention. The block connector is generally characterized by mateable male 200 and female 250 connectors that capture therebetween one end of a fluid line in sealed relation with an adjoining section of the fluid line. The male connector 200 includes a conduit passage 201 dimensioned to receive the end of a conduit 300 therethrough, and a fastener passage 202 laterally offset from the conduit passage 201. Counter-bored opening 203 of larger diameter is dimensioned to receive the larger-diameter circumferential flange 301 defined on the conduit 300 so to the conduit is captured between the male 200 and female 250 connectors upon mated assembly thereof. The female connector 250 includes a conduit port 251 dimensioned to receive the terminal, pilot portion 302 of the conduit 300 therein, and a fastener stud 400, such as the threaded bolt shaft or stud depicted, mounted in laterally offset relation to the conduit port 251. Conduit port 251 further has secured thereto a section of fluid line, such as the illustrated conduit 350, extending from the female connector 250, as shown.

Either before of after conduit 300 is inserted into the conduit passage 201 of male connector 200 so that flange 301 is received in opening 203, pilot end 302 of the conduit 300 is inserted through the central opening 103 of the sealing washer (indicated generally at W) of the present invention until the sealing rings 110a, 111a are brought into contact with the opposing surface 303 of conduit flange 301. Here it is notable that, per the illustrated embodiment, the depth of the opening 203 is such that the plane defined by surface 102 of the sealing washer is approximately flush with the inner edge 204 of the chamfered surface 205 defining the mouth of opening 203, thereby exposing the sealing rings 110b, 111b above the mating surface 206 of the male connector 200 to a degree which permits sealing contact with the mating surface 252 of the female connector block 250 but does not expose the sealing rings to over-compression in the assembled block connector.

Thereafter, the pilot end of the conduit 300 is inserted into conduit port 251 while, simultaneously, the male connector 200 is positioned so that the fastener stud 400 is received through fastener passage 202. A fastener 401, such as the illustrated nut, is then tightened on the fastener stud 400 to fix the male 200 and female 250 connectors so that the washer W is compressed between the opposing surface 302 conduit flange 301 and the mating surface 252 of the female connector block 250 in the assembled block connector. Under such axial compression, the sealing rings 110a, 111a, 110b, 111b, are compressed against these surfaces 302, 252 to form a seal (in the case of at least the sealing rings 110a, 110b, a fluid-tight seal). Further, such compression urges the lip 114 into sealing contact with the exterior surface 303 of the fluid conduit 300.

From the foregoing description, it will be appreciated that the disadvantages attending prior art sealing means are addressed, including in block connectors.

The foregoing description of the exemplary embodiments of the invention have been presented for purposes of illustration and description. They are not intended to be exhaustive of, or to limit, the invention to the precise forms disclosed, and modifications and variations are possible in light of the above teachings or may be acquired from practice of the innovation. The embodiments shown and described in order to explain the principals of the innovation and its practical application to enable one skilled in the art to utilize the innovation in various embodiments and with various modifications as are suited to the particular use contemplated. Accordingly, all such modifications and embodiments are intended to be included within the scope of the present invention. Other substitutions, modifications, changes and omissions may be made in the design, operating conditions and arrangement of the exemplary embodiments without departing from the spirit of the present innovations.

The invention in which an exclusive property or privilege is claimed is defined as follows:

1. A sealing washer, comprising:
a rigid body having opposite, disc-shaped surfaces defining parallel planes, and a central opening defined through the rigid body along a central axis thereof; and
multiple, concentric, polymeric sealing rings projecting away from the plane defined by each of the disc-shaped surfaces of the rigid body, the sealing rings being generally coaxial with the central axis, and each sealing ring being deformable in response to compression forces applied to the plane defined by each disc-shaped surface.

2. The sealing washer of claim 1, wherein the rigid body is made of metal.

3. The sealing washer of claim 1, wherein two such polymeric sealing rings project away from the plane defined by each of the disc-shaped surfaces of the rigid body.

4. The sealing washer of claim 1, wherein three such polymeric sealing rings project away from the plane defined by each of the disc-shaped surfaces of the rigid body.

5. The sealing washer of claim 4, wherein the three polymeric sealing rings projecting away from the plane defined by each of the disc-shaped surfaces of the rigid body each project to the same height as measured from the apex of each such sealing ring to the plane defined by the disc-shaped surface from which they project.

6. The sealing washer of claim 4, wherein one or more of the three polymeric sealing rings projecting away from the plane defined by each of the disc-shaped surfaces of the rigid body projects to a different height than the other polymeric sealing rings as measured from the apex of each such sealing ring to the plane defined by the disc-shaped surface from which they project.

7. The sealing washer of claim 6, wherein the three polymeric sealing rings projecting away from the plane defined by each of the disc-shaped surfaces of the rigid body each project to a different height, with the height of each successive concentric sealing ring increasing as measured in the direction from the central opening moving radially outwardly.

8. The sealing washer of claim 6, wherein the two innermost of the three concentric polymeric sealing rings projecting away from the plane defined by each of the disc-shaped surfaces of the rigid body project to the same height, while the height of outermost of the three concentric polymeric sealing rings projecting away from the plane defined by each of the disc-shaped surfaces of the rigid body projects to a greater height than the two innermost sealing rings.

9. The sealing washer of claim 1, wherein the rigid body is at least partially covered with a polymeric coating, and wherein the sealing rings are formed integrally with the polymeric coating.

10. The sealing washer of claim 9, wherein the rigid body is completely covered with the polymeric coating.

11. The sealing washer of claim 1, further comprising an annular polymeric lip extending from the rigid body into the central opening.

12. The sealing washer of claim 11, wherein the rigid body is at least partially covered with a polymeric coating, and wherein the sealing rings and the annular polymeric lip are all integrally formed with the polymeric coating.

13. The sealing washer of claim 12, wherein the rigid body is completely covered with the polymeric coating.

14. The sealing washer of claim 9, further comprising an annular polymeric lip extending from the rigid body into the central opening.

15. The sealing washer of claim 14, wherein the annular polymeric lip is integral with the polymeric coating.

16. The sealing washer of claim 15, wherein the rigid body is completely covered with the polymeric coating.

17. The sealing washer of claim 1, wherein the multiple polymeric sealing rings projecting away from the plane defined by each of the disc-shaped surfaces of the rigid body each project to the same height as measured from the apex of each such sealing ring to the plane defined by the disc-shaped surface from which they project.

18. The sealing washer of claim 1, wherein one or more of the multiple polymeric sealing rings projecting away from the plane defined by each of the disc-shaped surfaces of the rigid body projects to a different height than the other polymeric sealing rings as measured from the apex of each such sealing ring to the plane defined by the disc-shaped surface from which they project.

19. The sealing washer of claim 18, wherein each of the multiple, concentric polymeric sealing rings projecting away from the plane defined by each of the disc-shaped surfaces of the rigid body projects to a different height, with the height of each successive concentric sealing ring increasing as measured in the direction from the central opening moving radially outwardly.

20. The sealing washer of claim 18, wherein at least three such concentric polymeric sealing rings project away from the plane defined by each of the disc-shaped surfaces of the rigid body, and wherein further the two innermost of the at least three concentric polymeric sealing rings projecting away from the plane defined by each of the disc-shaped surfaces of the rigid body project to the same height, while the height of each successive concentric sealing ring, as measured in the direction from the central opening moving radially outwardly, projects to a greater height than the two innermost sealing rings.

21. In a block connector comprising a male connector having a conduit passage and at least one fastener passage laterally offset from the conduit passage, a female connector having a conduit port and at least one fastener stud laterally offset from the conduit port and receivable within the at least one fastener passage, a conduit disposed in the conduit passage and receivable within the conduit port, and a seal disposed about an exterior surface of the conduit and compressed between the male and female connectors to form a fluid-tight seal, the improvement comprising:
the seal being a sealing washer comprising (a) a rigid body having opposite, disc-shaped surfaces defining parallel planes, and a central opening defined through the rigid body along a central axis thereof for receiving therethrough the conduit; and
multiple, concentric, polymeric sealing rings projecting away from the plane defined by each of the disc-shaped surfaces of the rigid body, the sealing rings being generally coaxial with the central axis, and each sealing ring being deformable in response to compression forces applied by the male and female connectors to the plane defined by each disc-shaped surface.

22. The improved block connector of claim 21, wherein the rigid body of the sealing washer is made of metal.

23. The improved block connector of claim 21, wherein two such polymeric sealing rings project away from the plane defined by each of the disc-shaped surfaces of the rigid body.

24. The improved block connector of claim 21, wherein three such polymeric sealing rings project away from the plane defined by each of the disc-shaped surfaces of the rigid body.

25. The improved block connector of claim 21, wherein the three polymeric sealing rings projecting away from the plane defined by each of the disc-shaped surfaces of the rigid body each project to the same height as measured from the apex of each such sealing ring to the plane defined by the disc-shaped surface from which they project.

26. The improved block connector of claim 21, wherein one or more of the three polymeric sealing rings projecting away from the plane defined by each of the disc-shaped surfaces of the rigid body projects to a different height than the other polymeric sealing rings as measured from the apex of each such sealing ring to the plane defined by the disc-shaped surface from which they project.

27. The improved block connector of claim 26, wherein the three polymeric sealing rings projecting away from the plane defined by each of the disc-shaped surfaces of the rigid body each project to a different height, with the height of each successive concentric sealing ring increasing as measured in the direction from the central opening moving radially outwardly.

28. The improved block connector of claim 26, wherein the two innermost of the three concentric polymeric sealing rings projecting away from the plane defined by each of the disc-shaped surfaces of the rigid body project to the same height, while the height of outermost of the three concentric polymeric sealing rings projecting away from the plane defined by each of the disc-shaped surfaces of the rigid body projects to a greater height than the two innermost sealing rings.

29. The improved block connector of claim 21, wherein the rigid body is at least partially covered with a polymeric coating, and wherein the sealing rings are formed integrally with the polymeric coating.

30. The improved block connector of claim 29, wherein the rigid body is completely covered with the polymeric coating.

31. The improved block connector of claim 21, further comprising an annular polymeric lip extending from the rigid body into the central opening.

32. The improved block connector of claim 21, wherein the rigid body is at least partially covered with a polymeric coating, and wherein the sealing rings and the annular polymeric lip are all integrally formed with the polymeric coating.

33. The improved block connector of claim 32, wherein the rigid body is completely covered with the polymeric coating.

34. The improved block connector of claim 21, wherein the multiple polymeric sealing rings projecting away from the plane defined by each of the disc-shaped surfaces of the rigid body each project to the same height as measured from the apex of each such sealing ring to the plane defined by the disc-shaped surface from which they project.

35. The improved block connector of claim 21, wherein one or more of the multiple polymeric sealing rings projecting away from the plane defined by each of the disc-shaped surfaces of the rigid body projects to a different height than the other polymeric sealing rings as measured from the apex of each such sealing ring to the plane defined by the disc-shaped surface from which they project.

36. The improved block connector of claim 35, wherein each of the multiple, concentric polymeric sealing rings projecting away from the plane defined by each of the disc-shaped surfaces of the rigid body projects to a different height, with the height of each successive concentric sealing ring increasing as measured in the direction from the central opening moving radially outwardly.

37. The improved block connector of claim 35, wherein at least three such concentric polymeric sealing rings project away from the plane defined by each of the disc-shaped surfaces of the rigid body, and wherein further the two innermost of the at least three concentric polymeric sealing rings projecting away from the plane defined by each of the disc-shaped surfaces of the rigid body project to the same height, while the height of each successive concentric sealing ring, as measured in the direction from the central opening moving radially outwardly, projects to a greater height than the two innermost sealing rings.
